(19) United States
(12) Patent Application Publication
(10) Pub. No.: US 2021/0334410 A1
(43) Pub. Date: Oct. 28, 2021

(54) UPDATING A SECURITY POLICY

(71) Applicant: HEWLETT-PACKARD DEVELOPMENT COMPANY, L.P., Spring, TX (US)

(72) Inventors: Ijlal Loutfi, Bristol (GB); David Plaquin, Bristol (GB)

(21) Appl. No.: 16/604,160

(22) PCT Filed: May 2, 2018
(86) PCT No.: PCT/US2018/030661

§ 371 Date: Oct. 9, 2019

(51) Int. Cl. G06F 21/74; G06F 21/79; H04L 9/32

(52) U.S. Cl. CPC G06F 21/74; H04L 9/3236; G06F 21/79

(57) ABSTRACT

An example computing system is disclosed comprising storage to store a plurality of security policies for respective applications and storing, for each security policy, a respective security policy digest representing the security policy, a secure hardware component to store a digest of the security policy digests, and a processor to execute a software component to update the respective security policy digest of a first security policy of the plurality of security policies in response to an update to the first security policy, and to cause the secure hardware component to store an updated digest of the security policy digests.

### BACKGROUND

A computing system may include a number of software modules or applications executing on the computing system. Each module or application may be associated with a respective security policy, which may indicate how the module or application is to operate in certain situations. For example, the security policy may indicate resources of the computing system that the module or application may or may not access.

### BRIEF DESCRIPTION OF DRAWINGS

Examples will now be described, by way of non-limiting example, with reference to the accompanying drawings, in which:

FIG. 1 is a simplified schematic of an example of a computing system;

FIG. 2 is flow chart of a method of updating a security policy;

FIG. 3 is flow chart of a method of updating a security policy; and

FIG. 4 is a simplified schematic of an example of a computing system.

### DETAILED DESCRIPTION

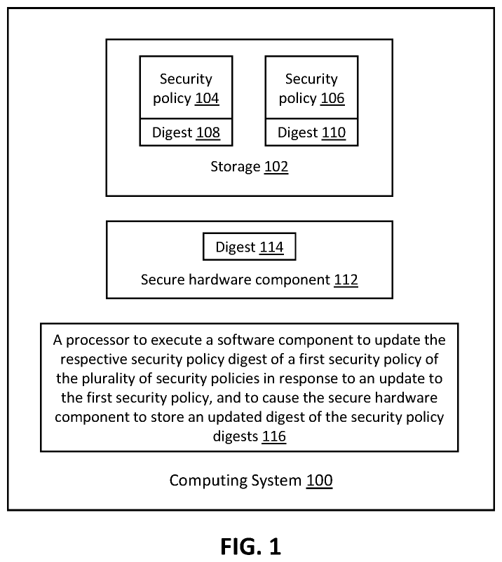

FIG. 1 is a simplified schematic of an example of a computing system 100. The computing system comprises storage 102 to store a plurality of security policies 104, 106 for respective applications (not shown) and storing, for each security policy, a respective security policy digest 108, 110 representing the security policy. There may be any number of security policies and respective digests. The applications (not shown) may in some examples execute on the computing system 100 and/or one or more remote computing systems. The security policy digest for a security policy may be for example a hash value of all or part of the security policy, or any value that represents the security policy.

The system 100 also includes a secure hardware component 112 to store a digest 114 of the security policy digests 108, 110. The secure hardware component may be in some examples a trusted processor or a cryptographic component (CC). In some examples, the digest 114 may be stored in storage that is accessible to the secure hardware component 112 (e.g. internal storage of the secure hardware component 112) and may be generally inaccessible by other components of the computing system 100. The digest 114 may in some examples be a hash value produced from all of the security policy digests 108, 110. Therefore, in some examples, the digest 114 may represent all of the security policies 104, 106. If, for example, one of the security policies 104, 106 is changed, the associated stored digest 108, 110 will be invalid, and hence the digest 114 will be invalid. Therefore, in some examples, the digest 114 and/or digests 108, 110 may be used to detect unauthorized changes to a security policy 104, 106.

The computing system 100 also comprises a processor 116 to execute a software component to update the respective security policy digest of a first security policy of the plurality of security policies 104, 106 in response to an update to the first security policy, and to cause the secure hardware component to store an updated digest of the security policy digests 108, 110.

For example, the processor 116 may execute the software component to update security policy digest 108 in response to an update of the security policy 104. In some examples, the software component may perform the update of the digest 108 in response to a request from an authorized party. The authorized party may in some examples be the application associated with the security policy 104, a manufacturer of the computing system 100, or any other authorized party. The software component may in some examples determine that the request is from an authorized party by determining that the request is signed and/or encrypted by an authorized party, for example using a credential such as a key of a symmetric or asymmetric key pair.

The software component may then update the digest 108, for example by computing a new digest and storing the new digest in place of the previous digest 108. The software component may in some examples request another component to compute and/or store the updated digest 108, for example the secure hardware component 112. The software component may also cause the secure hardware component 112 to store an updated digest 114 of the digests 108, 110, including the updated digest 108. This may be done for example by the software component computing the updated digest 114 and providing it to the secure hardware component 112, or by the software component sending a request to the secure hardware component 112 to compute and store a new digest 114 of the security policy digests 108, 110. In some examples, any communication between the software component may be secured, e.g. signed and/or encrypted, using a credential such as a symmetric or asymmetric key pair. In some examples, the processor may provide functionality to secure the software component and/or the credential, such as for example by encrypting a memory space associated with the software component or credential or by preventing another software module or application from accessing the memory space. Examples of such functionality include Software Guard Extensions (SGX).

Thus, in some examples, the secure hardware component 112 may store an update digest 114 that represents the digests 108, 110 and thus the security policies 104, 106, even in the event of an authorized update to one or more of the security policies 104, 106. Unauthorized changes to the security policies may be detected in some examples due to the stored digests 108, 110 which may not match a newly computed digest (e.g. computed during a verification process) computed from the security policies 104, 106. In some examples, even if an unauthorized change is also made to one or more digests 108, 110 to cause them to match an unauthorized change to one or more security policies 104, 106, this may be detected as the digest 114 may not match a newly computed digest (e.g. computed during a verification process) of the digests 108, 110.

In some examples, the computing system 100 stores a key (e.g. in a memory of the computing system 100) to authenticate a request to update the first security policy, and the processor is to update the first security policy in response to the request. For example, the key may decrypt the request or verify that the request is signed by a trusted source.

In some examples, the computing system 100 comprises an interface to, in response to a request to verify a selected security policy of the security policies, verify the selected security policy by verifying the security policy digest representing the selected security policy and verifying the digest of the security policy digests. For example, the request to verify may be received via the interface (e.g. a software interface provided by the software nodule, or an interface provided by the secure hardware component 112) from a party such as an application associated with the selected security policy. The verification may in some examples include computing a digest (e.g. hash value) of the selected security policy, and comparing the computed digest with the corresponding digest 108, 110 stored in the storage 102. The verification may also in some examples comprise computing a digest of the security digests 108, 110 and comparing this computed digest with the digest 114 stored in the secure hardware component 112. In some examples, if the verification indicates that the security policies have not changed, e.g. the digests 108, 110 and 114 are valid, then the interface is to provide an indication (e.g. to the sender of the request to verify) upon verification of the security policy digest representing the selected security policy and verification of the digest of the security policy digests. For example, the interface is to provide the indication to the application associated with the selected security policy.

In some examples, the processor 116 is to execute the software component to cause the secure hardware component 112 to store the updated digest of the security policy digests by causing the software component to send a message to the secure hardware component 112 using a secure communication channel between the software component and the secure hardware component. For example, the software component may include a credential, such as for example a key of a key pair, which may allow the software component to encrypt and/or sign the message before sending it to the secure hardware component. In some examples, the secure hardware component 112 may be able to decrypt the message and/or verify its signature, for example using a second key of the key pair. In some examples, the processor 116 is to secure an area of memory associated with the software component, the area of memory storing a key associated with the secure communication channel. For example, the area of memory may be secured using SGX.

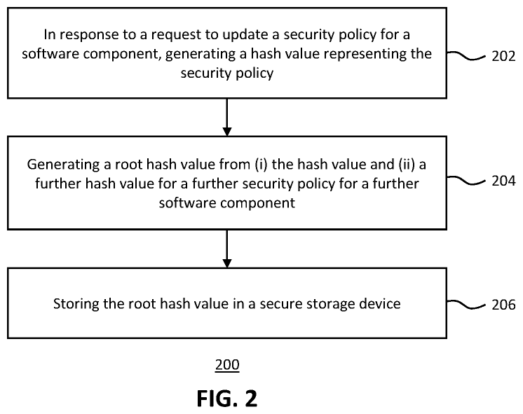

FIG. 2 is a flow chart of a method 200 of updating a security policy, for example a security policy for a software component or application. The method 200 comprises, in block 202, in response to a request to update a security policy for a software component, generating a hash value representing the security policy. The request to update the security policy may in some examples be received from the software component, and/or may be encrypted and/or signed using a credential to allow the request to be authenticated.

The method 200 also comprises, in block 204, generating a root hash value from (i) the hash value and (ii) a further hash value for a further security policy for a further software component, and in block 206, storing the root hash value in a secure storage device. Therefore, in some examples, the integrity of the security policy and the further security policy may be verified by checking that the hash value and the further hash value match their respective security policies (e.g. by recalculating the hash values for the security policies and comparing them to previously generated and stored hash values), and by checking that the root hash value matches the hash value and further hash value (e.g. by recalculating the root hash value and comparing it with the stored root hash value). Any unauthorized changes to any of the security policies may in some examples ultimately result in a root hash value which is different to the value stored in the secure storage device, and hence may be detected.

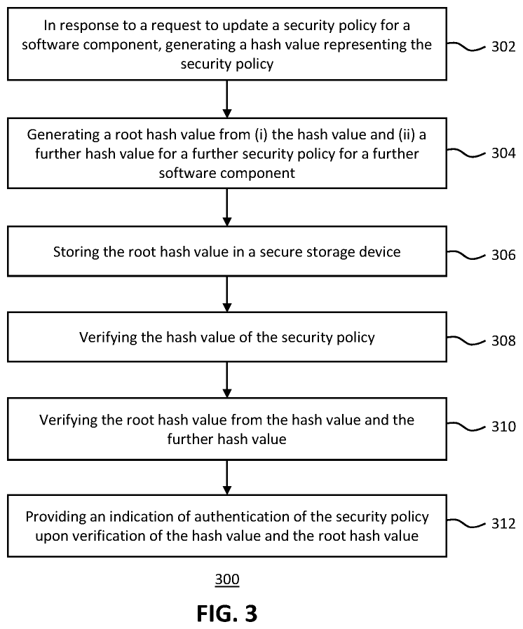

FIG. 3 is a flow chart of a method 300 of updating a security policy, for example a security policy for a software component or application. The method 300 comprises, in block 302, in response to a request to update a security policy for a software component, generating a hash value representing the security policy. The method 300 also comprises, in block 304, generating a root hash value from (i) the hash value and (ii) a further hash value for a further security policy for a further software component, and in block 306, storing the root hash value in a secure storage device. In some examples, the blocks 302, 304 and 306 of the method 300 are similar or identical to the blocks 202, 204 and 206 respectively of the method 200 described above with reference to FIG. 2.

The method 300 also comprises, in response to a request to authenticate the security policy (e.g. from an application wishing to verify that its security policy is valid), in block 308, verifying the hash value of the security policy. This may be done by for example recalculating the hash value of the security policy and comparing it to a previously calculated hash value. Block 310 comprises verifying the root hash value from the hash value and the further hash value, for example by recalculating the root hash value and comparing the result with the root hash value in the secure storage. Block 312 of the method comprises providing an indication of authentication of the security policy upon verification of the hash value and the root hash value, such as for example providing the indication to the application associated with the security policy and/or the sender of the request to authenticate.

In some examples, storing the root hash value in a secure storage device comprises sending a message to a secure processor using a secure communication channel to cause the secure processor to store the root hash value in the secure storage device. In some examples, the message includes the root hash value.

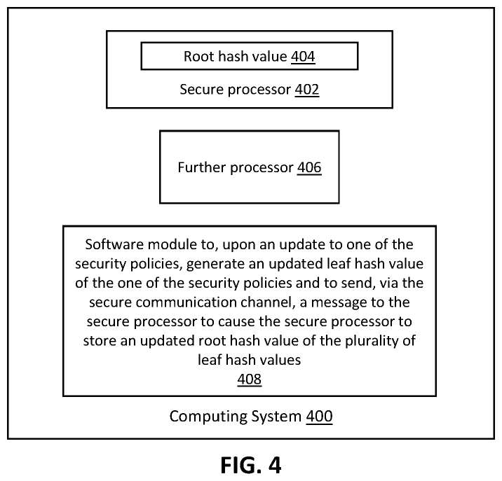

FIG. 4 is a simplified schematic of an example of a computing system 400 comprising a secure processor 402 to store a root hash value 404 of a plurality of leaf hash values, each leaf hash value representing a respective security policy. The system 400 also includes a further processor 406 to execute a software module 408 and to provide a secure communication channel from the software module to the secure processor 402.

The software module 408 is to, upon an update to one of the security policies, generate an updated leaf hash value of the one of the security policies and to send, via the secure communication channel, a message to the secure processor to cause the secure processor to store an updated root hash value of the plurality of leaf hash values.

In some examples, the computing system 400 is to, in response to a request to verify a first security policy of the security policies, verify the leaf hash value of the first security policy, verify the root hash value of the plurality of leaf hash values, and provide an indication of the verification of the leaf hash value and the root hash value.

In some examples, the further processor 406 is to secure an area of memory associated with the software module (e.g. using SGX or other functionality), the area of memory storing a key associated with the secure communication channel. In some examples, the area of memory also stores the instruction and/or data of the software module.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A computing system comprising:
storage to store a plurality of security policies for respective applications and storing, for each security policy, a respective security policy digest representing the security policy;
a secure hardware component to store a digest of the security policy digests; and
a processor to execute a software component to update the respective security policy digest of a first security policy of the plurality of security policies in response to an update to the first security policy, and to cause the secure hardware component to store an updated digest of the security policy digests.

2. The computing system of claim 1, wherein the computing system stores a key to authenticate a request to update the first security policy, and the processor is to update the first security policy in response to the request.

3. The computing system of claim 1, comprising an interface to, in response to a request to verify a selected security policy of the security policies, verify the selected security policy by verifying the security policy digest representing the selected security policy and verifying the digest of the security policy digests.

4. The computing system of claim 3, wherein the interface is provided by one of the secure hardware component and the software component.

5. The computing system of claim 3, wherein the interface is to provide an indication upon verification of the security policy digest representing the selected security policy and verification of the digest of the security policy digests.

6. The computing system of claim 5, wherein the interface is to provide the indication to the application associated with the selected security policy.

7. The computing system of claim 1, wherein the processor is to execute the software component to cause the secure hardware component to store the updated digest of the security policy digests by causing the software component to send a message to the secure hardware component using a secure communication channel between the software component and the secure hardware component.

8. The computing system of claim 7, wherein the processor is to secure an area of memory associated with the software component, the area of memory storing a key associated with the secure communication channel.

9. A method of updating a security policy, the method comprising:
in response to a request to update a security policy for a software component, generating a hash value representing the security policy;
generating a root hash value from (i) the hash value and (ii) a further hash value for a further security policy for a further software component; and
storing the root hash value in a secure storage device.

10. The method of claim 9, further comprising, in response to a request to authenticate the security policy:
verifying the hash value of the security policy;
verifying the root hash value from the hash value and the further hash value; and
providing an indication of authentication of the security policy upon verification of the hash value and the root hash value.

11. The method of claim 9, wherein storing the root hash value in a secure storage device comprises sending a message to a secure processor using a secure communication channel to cause the secure processor to store the root hash value in the secure storage device.

12. The method of claim 9, further comprising, in response to a request to update a security policy for a software component, using a key to authenticate the request.

13. A computing system comprising:
a secure processor to store a root hash value of a plurality of leaf hash values, each leaf hash value representing a respective security policy;
a further processor to execute a software module and to provide a secure communication channel from the software module to the secure processor;
the software module to, upon an update to one of the security policies, generate an updated leaf hash value of the one of the security policies and to send, via the secure communication channel, a message to the secure processor to cause the secure processor to store an updated root hash value of the plurality of leaf hash values.

14. The computing system of claim 13, wherein the computing system is to, in response to a request to verify a first security policy of the security policies, verify the leaf hash value of the first security policy, verify the root hash value of the plurality of leaf hash values, and provide an indication of the verification of the leaf hash value and the root hash value.

15. The computing system of claim 13, wherein the further processor is to secure an area of memory associated with the software module, the area of memory storing a key associated with the secure communication channel.
